(19) United States
(12) Patent Application Publication
(10) Pub. No.: US 2009/0069020 A1
(43) Pub. Date: Mar. 12, 2009

(54) Dynamic On-Off Spectrum Access Scheme to Enhance Spectrum Efficiency

(76) Inventors: Beibei Wang, Greenbelt, MD (US); Chia-Chin Chong, Santa Clara, CA (US); Fujio Watanabe, Union City, CA (US)

Correspondence Address: MACPHERSON KWOK CHEN & HEID LLP, 2033 GATEWAY PLACE, SUITE 400, SAN JOSE, CA, 95110, US

(21) Appl. No.: 12/192,359

(22) Filed: Aug. 15, 2008

Related U.S. Application Data
(60) Provisional application No. 60/970,833, filed on Sep. 7, 2007.

(51) Int. Cl. H04W 40/00

(52) U.S. Cl. 455/446; 455/452.2

(57) ABSTRACT

The following invention related to a dynamic on-off spectrum access scheme that will coordinate among different cells, sharing the same spectrum band and enhance spectrum efficiency. Based on the proposed scheme, in particular, the cells or sectors are classified to different types according to their geographical locations. Different types of cells or sectors occupy the total available frequency in a time-sharing fashion, and the duration or priority of the “on” state for each type is chosen based on users' quality of service (QoS) demand.

### CROSS REFERENCE TO RELATED APPLICATIONS

The present application is related to and claims priority of copending U.S. provisional patent application (the “Provisional Application”), entitled “Dynamic On-Off Spectrum Access Scheme to Enhance Spectrum Efficiency,” listing Beibei Wang et al. as inventors, Ser. No. 60/970,833, filed on Sep. 7, 2007. The disclosure of Provisional Application is hereby incorporated herein by reference in its entirety.

### BACKGROUND OF THE INVENTION

1. Field of the Invention

The present application relates to mobile communication. In particular, the present invention provides an efficient scheme for sharing spectrum resources among multiple cells in a cellular communication network while reducing interference.

2. Discussion of the Related Art

As the demand for wireless cellular services continues to increase, the available wireless spectrum becomes more crowded. There is great interest, therefore, in optimally utilizing the limited spectrum resources to provide high quality of service (QoS). Without an efficient spectrum access scheme, a cellular user will likely experience heavy interference from both intra-cell and inter-cell mobile users. Such interference includes co-channel interference (CCI), and neighbor-channel interference (NCI). Novel spectrum or channel access schemes are necessary to suppress such interference in order to ensure acceptable QoS and efficient spectrum utilization.

In order to improve spectrum efficiency and to avoid interference due to reuse of the same channel, the spectrum frequencies are carefully planned to accommodate different mobile users in different cells. One example of frequency planning is referred to as “static or deterministic frequency planning.” Examples of static or deterministic frequency planning include:
(a) U.S. Pat. No. 6,574,456, entitled “Method of Preventing Interference of Adjacent Frequencies in a Cellular System by Selection between Adjacent Carrier Frequency and Non-Adjacent Carrier Frequency,” to Hamabe, discloses a method for preventing interference from adjacent frequencies from other cellular systems that are in use, based on a received interference power level.
(b) U.S. Patent Application Publication 2005/0111408 (“Skillermark”), entitled “Selective Interference Cancellation,” by P. Skillermark and T. Sundin discloses a mobile station (MS) design for a time division-code division multiple access (TD-CDMA) cellular system, which maintains a list of intra-cell interferers and detects inter-cell interferers (ICIs) using handover related information. Skillermark also discloses interference cancellation methods developed using a joint detection algorithm.
(c) U.S. Pat. No. 5,862,124, entitled “Method for Interference Cancellation in a Cellular CDMA Network,” by A. Hottinen et al., provides an interference cancellation scheme in a cellular CDMA network. The interference cancellation scheme controls the usage of a carrier frequency by multiple co-located cells.
(d) U.S. Pat. No. 5,365,571, entitled “Cellular System Having Frequency Plan and Cell Layout with Reduced Co-Channel Interference,” to P. Rha et al., discloses a cellular system having a frequency plan and cell layout method with reduced CCI.
(e) U.S. Pat. No. 6,754,496, entitled “Reducing Interference in Cellular Mobile Communications Networks,” to B. Mohebbi and M. J. Shearme, discloses a method for reducing ICI by including information about transmission property and preferred destination in the uplink and downlink signals.
(f) U.S. Pat. No. 4,384,362, entitled “Radio Communication System using Information Derivation Algorithm Coloring for Suppressing Co-channel Interference” to K. W. Leland, discloses, in a cellular communication system, reducing CCI which occurs in any given time slot by distributing the CCI to other time slots.
(g) (i) U.S. Pat. No. 5,740,536, entitled “System and Method for Managing Neighbor-Channel Interference in Channelized Cellular Systems,” (ii) U.S. Pat. No. 6,181,918, “System and method for management of neighbor-channel interference with cellular reuse partitioning,” and (iii) U.S. Pat. No. 6,128,498, entitled “System and method for management of neighbor-channel interference with power control and directed channel assignment,” all granted to M. Benveniste, disclose methods for managing NCI in channelized cellular systems, with cellular reuse partitioning and with power control and directed channel assignment.
(h) the article, entitled “Study of Inter-System Interference between Region One and Two Cellular Systems in the 2 GHz Band,” by A. Sathyendran, A. R. Murch, and M. Shafi, published in Proc. of 48^{th} IEEE Vehicular Technology Conference (VTC), Ottawa, Canada, May 1998, vol. 2, pp. 1310-1314, discloses performance degradation due to wide-band noise and inter-system interference in the 2-GHz band used for cellular systems. Based on this study, the authors determined the minimum guard-band and minimum distance separation requirements for multi-system coexistence.

Although the static or deterministic frequency planning methods enumerated above can alleviate intra-cell and ICI (to some extent) and increase the spectral efficiency, these methods assume a conventional static and deterministic channel reuse pattern being used in a cellular network with invariant channel conditions. Such an assumption is not appropriate for a network with high mobility and thus a time-varying CCI range. Hence, new spectrum resource allocation algorithms are needed to take into account the complicated effects of dynamic channel variations, and to optimally coordinate the spectrum resource sharing among different cells.

Some examples of dynamic channel allocation (DCA) methods include:
(a) The article, entitled “Multi-Cell Coordinated Radio Resource Management Scheme Using a Cell-Specific Sequence in OFDMA Cellular Systems” (“Kim”), by K. Kim and S. Oh, published in Proc. of 8^{th} IEEE Annual Wireless and Microwave Technology Conference (WAMICON), Clearwater, Fla., December 2006, pp. 1-5, discloses a multi-cell coordinated radio resource management scheme, which is applied to an orthogonal frequency division multiple access (OFDMA) cellular system. In Kim, each cell is provided its own sequence for allocating radio sub-channels. Each cell assumes initially that it can allocate from a predetermined set of sub-channels which is the same for each cell. From the set of sub-channels, the cell selects sub-channels based on a cell-specific sub-channel allocation sequence. As a result, the chances of ICI and major collisions from neighboring cells may be reduced.
(b) U.S. Pat. No. 6,671,309 (“Craig”), entitled “Interference Diversity in Communications Networks,” to S. G. Craig et al., discloses significantly improving system performance in a cellular radio system that employs frequency hopping, by exploiting interference diversity while maintaining frequency diversity. Craig disclose a technique that allocates to each MS operating in unsynchronized or synchronized cells both a frequency hopping sequence and a frequency offset hopping sequence, so as to increase both inter-cell and intra-cell interference diversity.
(c) the article, entitled “Inter-Sector Scheduling in Multi-User OFDM,” by A. Persson, T. Ottosson, and G. Auer, published in Proc. of IEEE International Conference on Communications (ICC), Istanbul, Turkey, June 2006, pp. 4415-4419, discloses achieving a higher spectrum efficiency using inter-sector scheduling in a multi-user orthogonal frequency division multiplexing (OFDM) system, where the buffered data at each base station (BS) is exchanged within a small group of BSs, such that the spectrum can be dynamically moved to a sector with the most current need.
(d) the article, entitled “An Effective Dynamic Slot Allocation Strategy Based on Zone Division in WCDMA/TDD Systems” (“Nazzarri”), by F. Nazzarri and R. F. Ormondroyd, published in Proc. of 56^{th} IEEE Vehicular Technology conference (VTC), Vancouver, Canada, September 2002, vol. 2, pp. 646-650, discloses that, in a multi-cellular environment, the traffic asymmetry between wideband code division multiple access (W-CDMA)-time division duplex (TDD) cells may be significantly different and the application of slot allocation strategies on a per cell basis can result in a high level of ICI during “crossed-slots”. Nazzari discloses an adaptive dynamic slot allocation strategy that resolves the crossed-slot interference in the multi-cell environment by dividing the coverage area of each cell into a number of distinct service zones. Under that allocation strategy, a coordination algorithm is applied that ensures that system resources are allocated to users according to the level of mutual interference between the service zones.

Compared with the fixed channel allocation (FCA) methods, DCA techniques improve the spectral efficiency and reduce CCI. However, DCA requires additional signaling overhead. The article, entitled “Interference Aware Medium Access in Cellular OFDMA/TDD Networks” (“Haas I”), by H. Haas, V. D. Nguyen, P. Omiyi, N. Nedev, and G. Auer, published in Proc. IEEE International Conference on Communications (ICC), Istanbul, Turkey, June 2006, pp. 1778-1783, discloses a decentralized interference-aware medium access scheme in a cellular OFDMA-TDD network. The medium access scheme enables the transmitter to determine the level of interference it would cause to already active links prior to transmissions through a busy-slot signaling that exploits the channel reciprocity of the TDD mode. Under this method, the system can operate with full frequency reuse and avoid significant CCI. In addition, the scheme in Haas I also performs an autonomous sub-carrier allocation that can dynamically adapt to time-varying channels.

Other methods for sharing spectral resources efficiently include, for example, distributed DCA and frequency planning with location information:
(a) The article, entitled “Distributed Wireless Channel Allocation in Networks with Mobile Base Stations” (“Nesargi”), by S. Nesargi and R. Prakash, published in IEEE Trans. Vehicular Technology, vol. 51, no. 6, pp. 1407-1421, November 2002, discloses a distributed spectrum allocation algorithm which employs principles of mutual exclusion techniques to assign disjoint sets of channels for both inter-BS wireless links and BS to mobile node links. Under this algorithm, the channel allocation scheme is distributed, dynamic and deadlock-free. In addition, CCI is reduced by rearranging or switching channel assignments among the mobile BSs (e.g., BS that are installed in trains and other vehicles) that are in the vicinity.
(b) The article, entitled “An Efficient Fault-Tolerant Distributed Channel Allocation Algorithm for Cellular Networks” (“Yang”), by J. Yang and D. Manivannan, published in IEEE Trans. Mobile Computing, vol. 4, no. 6, pp. 578-587, November 2005, discloses another efficient fault-tolerant distributed channel allocation algorithm for cellular networks. The goal of this algorithm is to reuse the limited spectrum resources, while controlling CCI from neighboring cells. Under this algorithm, when a cell needs a channel to support a call, it first checks its own set of allocated channel for an available channel. If no channel is available, the cell sends messages to its interference neighbors to obtain channel usage information. Based on the channel usage information obtained, the cell “borrows” an available channel according to an efficient fault-tolerant channel selection algorithm. This method thus achieves a good channel reuse pattern.

In the distributed traffic-adaptation DCA schemes of Nesargi and Yang, the channels are usually allocated to cells, rather than to the MSs. However, MSs in adjacent cells may still interfere with each other under a fixed reusability factor that is based on cell-level frequency planning. Further, it is also a waste of resources for the inner area of a cell, if each cell is assigned a distinct frequency band. This is because the frequency distribution to the different cells reduces the available resources per cell considerably (e.g., by a factor of ⅓ or even 1/7).

Many other DCA schemes have been investigated in the prior art. For example, one adaptation-based DCA scheme places channels in a pool and allocates the channels on-demand to the cells from the pool, based on a group of allocation rules (e.g., minimal distance rule). In many traffic-adaptation DCA schemes, the channels are usually allocated to cells, rather than to the MSs. However, MSs in adjacent cells may still interfere with each other under a fixed reusability factor as a result of cell-level frequency planning. Therefore, channel allocation to individual mobile users based on their locations may also be significant. For example, the article, entitled “Simulation Results of the Capacity of Cellular Systems” (“Haas II”), by Z. Haas, J. H. Winters, and D. Johnson, published in IEEE Trans. Vehicular Technology, vol. 46, no. 4, pp. 805-817, November 1997, studies the capacity of cellular systems with interference-adaptation DCA. Haas II uses a set of heuristics that evaluate the required channels given the knowledge of the MSs' locations, and investigate the effect of a number of parameters. Suitable parameters include the number of mobiles per cell and the minimum allowable signal-to-interference ratio.

Frequency planning often assigns a distinct sub-channel to an entire cell, which may therefore reduce the available resources for each cell and thus the overall system throughput. U.S. Patent Application Publication 2006/0292989, entitled ““Method of Uplink Interference Coordination in Single Frequency Networks, a Base Station, a Mobile Terminal and a Mobile Network therefore” (“Gerlach”), to C. G. Gerlach and B. Haberland, discloses a method for uplink interference coordination in a single-frequency network with frequency reuse and without soft handover. In particular, Gerlach's method partitions the frequency band into subsets, and MSs in neighboring cells that can interfere with each other are carefully allocated dedicated subsets of the frequency band and are limited in their power to avoid CCI.

As cognitive radio (CR) technology develops, the available spectrum utilization rate can be significantly increased using an opportunistic spectrum usage scheme. However, sensing the entire range of a spectrum can be costly, if the available range is large. Therefore, limiting the spectrum to be scanned is important. Since the spectrum usage concept depends on both time and space, by dividing the space into regions, and assigning small section of the spectrum to these regions can shorten the search (and thus, reduces the time and power required). The article, entitled “Exploiting Location Awareness towards Improved Wireless System Design in Cognitive Radio,” by S. Yarkan and H. Arslan, published in IEEE Communications Magazine, vol. 46, no. 1, pp. 128-136, January 2008, discloses making use of global positioning system (GPS) based location information to decrease the spectrum search space in a CR network.

### SUMMARY

The present invention provides a dynamic on-off spectrum access scheme to enhance spectrum efficiency. In particular, the cells or sectors are classified into different types according to their geographical locations. Different types of cells or sectors share the total available bandwidth in a TDD fashion, and the duration or priority of the “on” state for each type of cells or sectors is chosen based on users' QoS demand within the cells or sectors.

One advantage of this invention over prior art solutions is the full utilization of the spectrum without ICI, degradation or interruption of users' communication quality. The cells or sectors are classified to different types according to their geographical locations. Different types of cells or sectors occupy the total bandwidth in an interleaved fashion in the time domain, and the duration or priority of the “on” state for each type of cell is chosen based on the users' QoS demands.

The present invention is better understood upon consideration of the detailed description below in conjunction with the accompanying drawings.

### BRIEF DESCRIPTION OF THE DRAWINGS

FIGS. 1(a) and 1(b) illustrate 24 cells of a single-frequency cellular network configured into one sector per cell and three sectors per cell, respectively, sharing the same frequency band with a reuse factor of ⅓.

FIG. 2 shows a conventional frequency division scheme where the total bandwidth Bₜₒₜₐₗ is evenly divided among the three types of cells.

FIG. 3 shows an example of an on-off round-robin frequency usage pattern (“Class 1”) with fixed-time slot for the three types of cells, according to one embodiment of the present invention.

FIG. 4 illustrates an alternative pattern with fixed-time slot (“Class 2”) based on QoS demand priority, according to one embodiment of the present invention.

FIG. 5 depicts another alternative pattern (“Class 3”), which is based on the on-off round-robin frequency usage pattern, but provided with dynamic-time slots, in accordance with one embodiment of the present invention.

FIG. 6(a) and FIG. 6(b) depict the signaling exchange of the on-off spectrum access scheme, under control of an NC and under control of a group of interconnected BSs (i.e., without an NC), respectively, according to one embodiment of the present invention.

FIGS. 7(a) and 7(b) are flow charts which summarize, respectively, the operations for implementing the Class 2 and Class 3 usage patterns.

### DETAILED DESCRIPTION OF THE PREFERRED EMBODIMENTS

In an area where multiple cells of a single cellular network share the same frequency band, orthogonal transmission schemes such as Frequency Division Multiple Access (FDMA) can significantly reduce ICI. However, since the total frequency bandwidth is divided among the cells of the network, the bandwidth allocated to each cell may be insufficient to supporting high QoS demand (e.g., video-on-demand, multimedia streaming, video phone, or picture uploading or downloading applications, such as those defined IMT-Advanced Services and Applications Specification¹). If the user density inside a cell is high, such frequency division schemes may further deteriorate network performance. If the individual bandwidth to each cell is increase by adopting a frequency reuse factor of 1 (i.e., every cell uses the full bandwidth), the severe resulting ICI will disable user transmissions near the cell border. Hence, an adaptive access scheme is required to both utilize the spectrum as efficiently and manage ICI. ¹ITU-R Document 8F/TEMP/537: A PDNR IMT.SERV Framework for Services Supported by IMT, 30 May 2007.

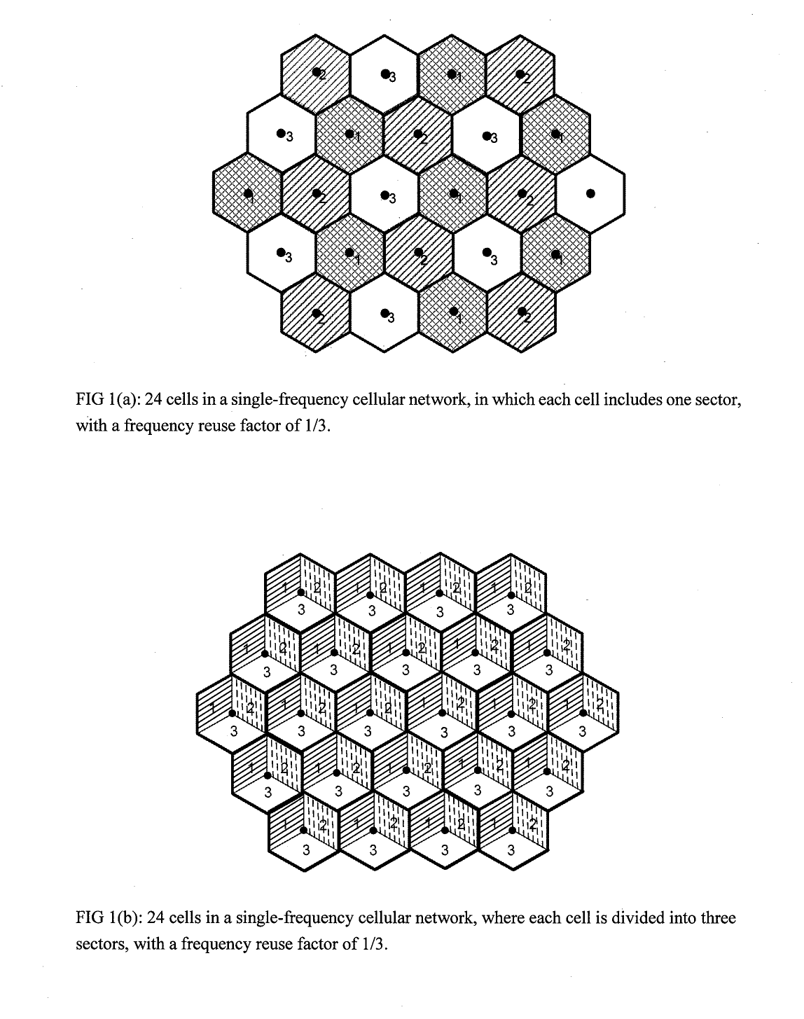

FIGS. 1(a) and 1(b) illustrate 24 cells of a single-frequency cellular network, which is configured to have one sector per cell and three sectors per cell, respectively, sharing the same frequency band with a reuse factor of ⅓. Based on their geographical locations, the cells are divided into three categories: namely, Type 1, Type 2 and Type 3. Under this scheme, neighboring cells are always classified into different types, and thus, do not use the same frequency band. Cells of the same type j, j=1, . . . 3, occupy the same frequency band.

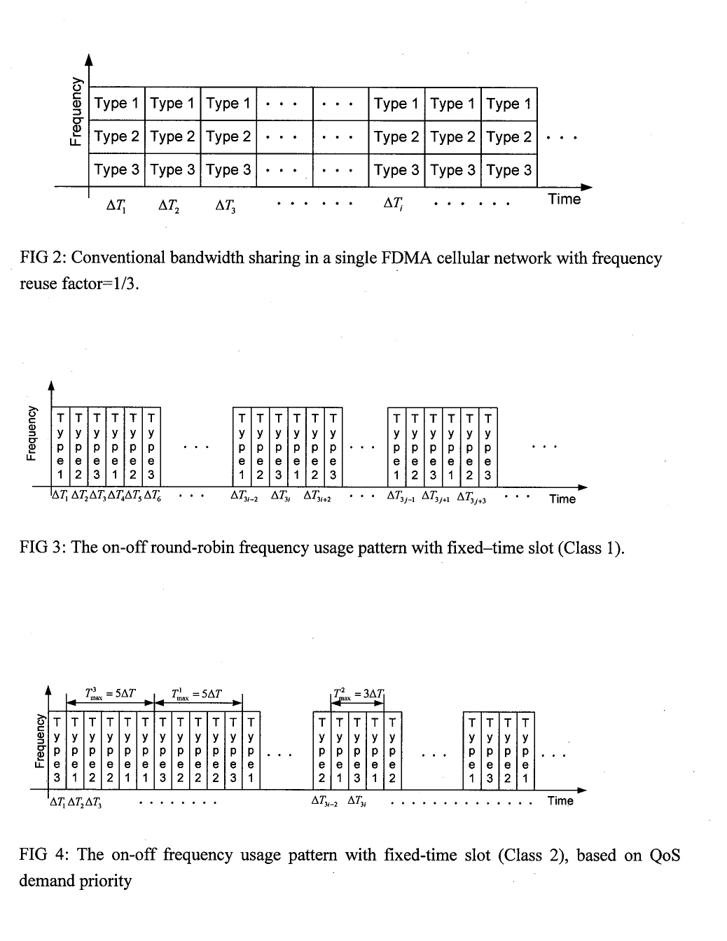

FIG. 2 shows a conventional frequency division scheme where the total system bandwidth Bₜₒₜₐₗ is evenly divided among the three types of cells (i.e., for the j^{th} type cell, the allocated bandwidth is B_{j,ΔT}_{ᵢ}, where

$${B}_{j} = \frac{1}{3} {B}_{total} ,$$

for any time slot ΔTᵢ). Under this conventional scheme, if the spectral efficiency of each cell is r b/s/Hz, then the peak transmission rate of each cell is at most rBⱼ b/s. However, according to one embodiment of the present invention, one type of cells is allowed to use the entire system bandwidth Bₜₒₜₐₗ for an assigned time period, so that the peak transmission rate is increased to 3rBⱼ b/s. While that one type of cells is occupying and using the entire band, no other type of cells can use any of the frequencies within the frequency band at the same time. In order to avoid ICI, a method of the present invention (“On-off round-robin frequency usage”) rotates assigning the entire frequency band to the cell types one at a time in an interleaved fashion, unless a Code Division Multiple Access (CDMA) scheme is used. Therefore, at any instance in time, one type of the cells is granted exclusive use of the entire frequency band.

FIG. 3 shows an example of an on-off round-robin frequency usage pattern (“Class 1”) with fixed-time slot of the three types of cells. As shown in FIG. 3, in a Class 1 pattern, at time slot ΔT₁, only Type 1 cells actively occupy the entire bandwidth Bₜₒₜₐₗ, while Type 2 and Type 3 cells are idle. At time slot ΔT₂, only Type 2 cells are active, while Type 1 and Type 3 cells are idle. In Class 1, each type of cells are in the “ON” state every third time slot. The duration of each ON/OFF state (ΔTᵢ) may be very small (e.g., around 2-5 milliseconds (ms)), so that frequency usage interruption at each type of cells is not noticeable. The selection of the value of ΔTᵢ is an implementation consideration, and depends on the cellular network operating carrier frequency and bandwidth (i.e., the channel coherence time).

In order to meet hierarchical QoS demand, other scheduling patterns may be used to allow multiple access for different types of cells other than the round-robin with fixed-time slot scheme of FIG. 3. For example, FIG. 4 illustrates an alternative pattern with fixed-time slot (“Class 2”) based on QoS demand priority. Under the Class 2 pattern, at initial time slot ΔT₁, a network controller (NC) selects randomly a type of cells to exclusively occupy the entire bandwidth Bₜₒₜₐₗ. At each subsequent time slot ΔTᵢ, i=1,2, . . . , the NC estimates the cumulative QoS demand (e.g., using such parameters as transmission rate or throughput, or blocking probability) for all Type j cells as Qⱼ(ΔTᵢ). Then, at the next time slot ΔTᵢ₊₁, the NC selects the type of cells with the greatest QoS during the last time slot, i.e.,

j*(ΔTᵢ₊₁)=arg max Qⱼ(ΔTᵢ). (1)

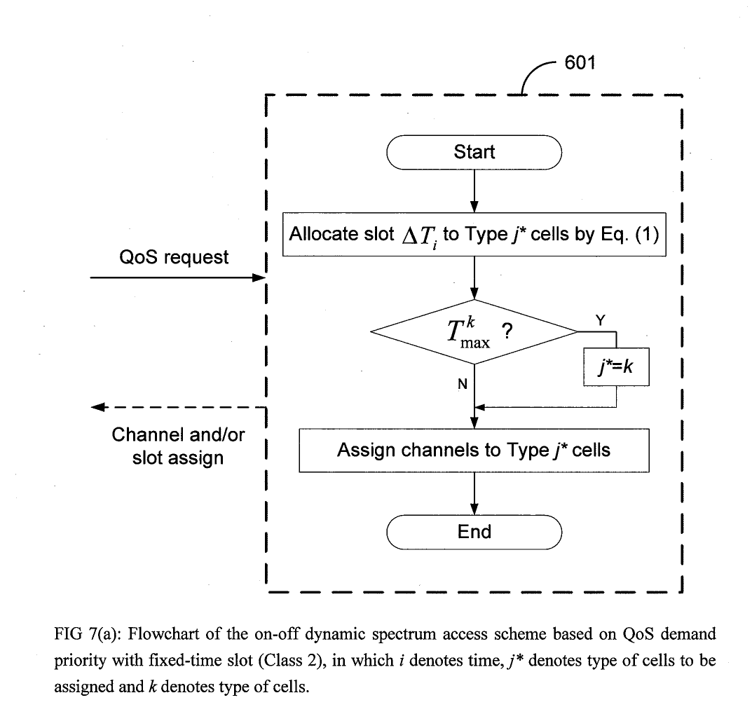

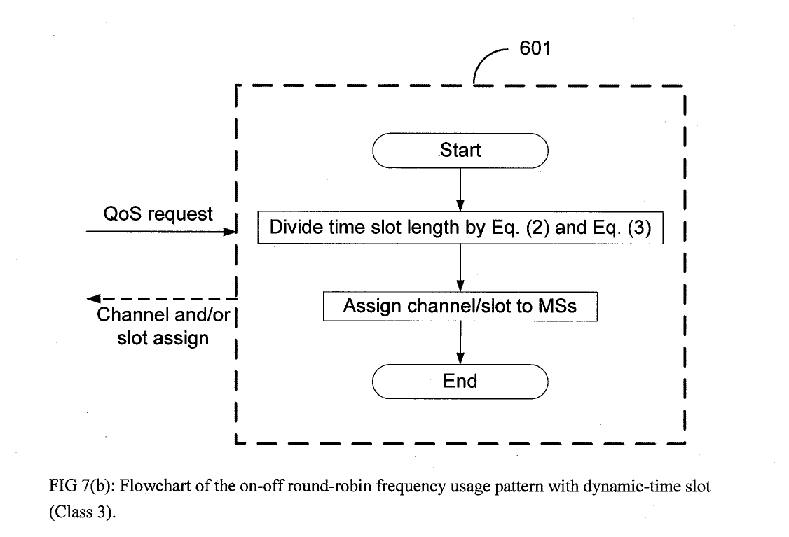

Based on the Class 2 selection pattern, the QoS metric of the network can be maximized. However, under this scheme, the time interval during which any given type of cells (i.e., Type ^{j}) occupy the frequency band cannot exceed a pre-determined threshold Tₘₐₓ^{j}, to avoid service interruption. The value of threshold Tₘₐₓ^{j} is selected based on the possibility of service interruption. The above-described operations for implementing the Class 2 usage pattern are summarized in the flow chart of FIG. 7(a).

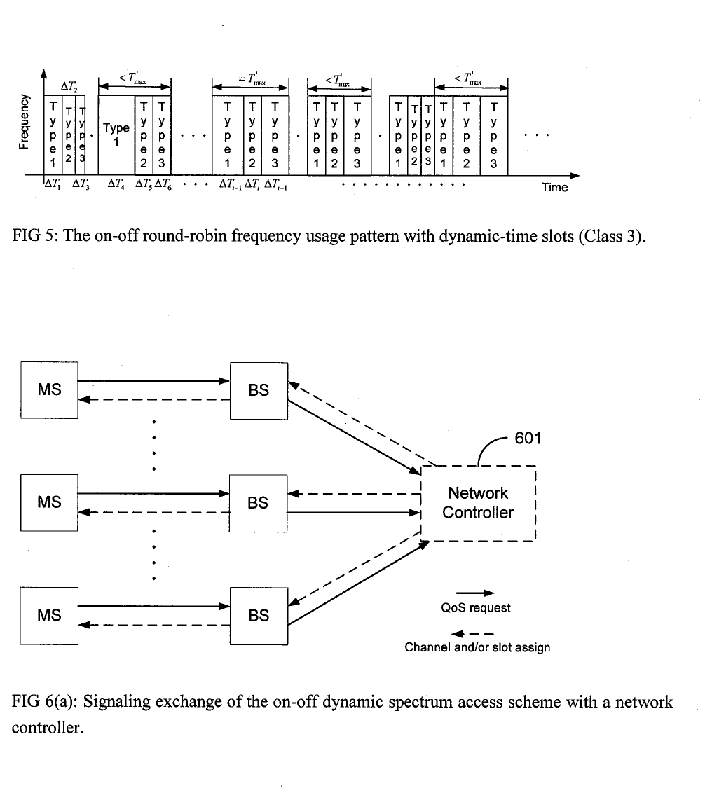

FIG. 5 depicts another alternative pattern (“Class 3”), which is based on the on-off round-robin frequency usage pattern, but provided with dynamic-time slots. Under the Class 3 pattern, while each type of cells are assigned the entire system bandwidth in round-robin order, the duration of each time slot may be adjusted to reflect the hierarchical QoS demand for the active types of cells. As shown in FIG. 5, at the beginning of each group of three consecutive time slots, ΔTᵢ₋₁, and ΔTᵢ₊₁, corresponding to the time slots assigned to Type 1, Type 2, and Type 3 cells, respectively, the NC estimate the QoS demand for each Type ^{j} of cells as Qⱼ, Then, the durations of time slots ΔTᵢ₋₁, ΔTᵢ, and ΔTᵢ₊₁ are determined according to the ratios:

ΔTᵢ₋₁:ΔTⱼ:ΔTᵢ₊₁=Q₁:Q₂:Q₃. (2)

The Class 3 pattern, therefore, provides greater fairness than the Class 1 pattern. However, the Class 3 pattern requires more precise timing and greater synchronization among different types of cells. Otherwise, heavy interference among the cells may occur, when more than one type of cells use the same bandwidth at the same time. Note that, to avoid service interruption, implicit in equation (2) is the following constraint on ΔTᵢ₋₁, ΔTᵢ, and ΔTᵢ₊₁:

ΔTᵢ₋₁+ΔTᵢ+ΔTᵢ₊₁≦Tₘₐₓ, (3)

where Tₘₐₓ represents the duration threshold beyond which service interruption may occur. The above-described operations for implementing the Class 3 usage pattern are summarized in the flow chart of FIG. 7(b).

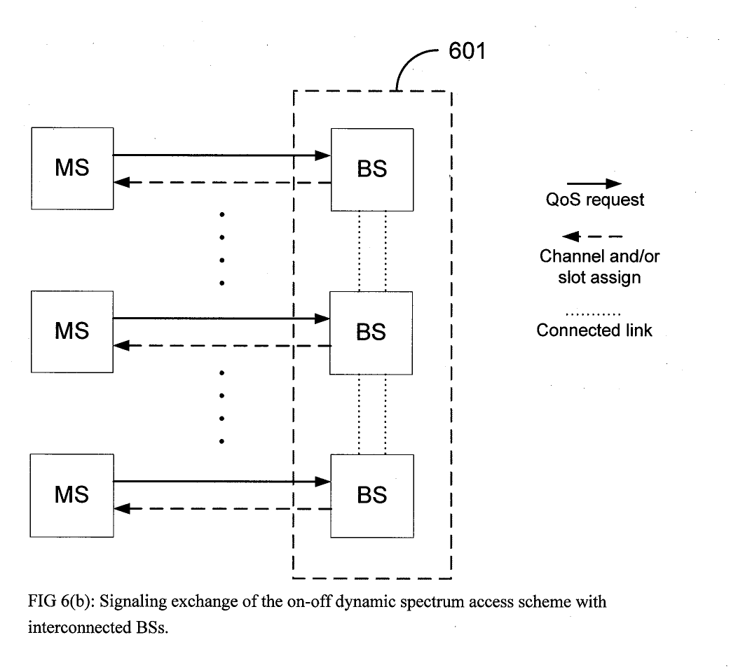

FIG. 6(a) and FIG. 6(b) depict the signaling exchange of the on-off spectrum access scheme, under control of an NC (i.e., NC 601) and under control of a group of interconnected BSs (i.e., without an NC), respectively. Note that any of the frequency usage patterns of the present invention can be controlled by the NC (i.e., as shown in FIG. 6(a)) or by the interconnected BSs (i.e., as shown in FIG. 6(b)).

The above detailed description is provided to illustrate the specific embodiments of the present invention and is not intended to be limiting. Numerous variations and modifications within the scope of the present invention are possible. The present invention is set forth in the following claims.

We claim:

1. In a cellular communication system, a method for assigning bandwidths to a plurality of cells for use in communication by mobile stations within the cells, comprising:
classifying the cells into a plurality of types, such that each cell of a given type is adjacent only to cells of types other than the given type; and
assigning a predetermined bandwidth exclusively for use in communication to each type of cells, one type at a time, according to a predetermined scheduling sequence and for a duration of time.

2. A method as in claim 1, wherein the scheduling sequence comprises a round-robin schedule.

3. A method as in claim 2, wherein the duration of time is fixed.

4. A method as in claim 2, wherein the duration of time varies according to a quality of service (QoS) demand metric computed in each type of cells.

5. A method as in claim 4, wherein the duration of time assigned to a type of cells is proportional to the QoS demand metric computed for that type of cells, relative to the QoS demand metrics computed across all the classified types of cells.

6. A method as in claim 5, wherein the durations of time in total assigned to all the classified type of cells in one rotation of the round-robin schedule do not exceed a predetermined maximum.

7. A method as in claim 6, wherein the predetermined maximum relates to a time period greater than which interruption of service may occur.

8. A method as in claim 1, wherein the scheduling sequence assigns selects a type of cells to assign the bandwidth prior to the beginning of each duration of time.

9. A method as in claim 8, wherein the scheduling sequence selects the type of cells according to a quality of service (QoS) demand metric computed for each type of cells at the beginning of each duration of time.

10. A method as in claim 9, wherein the scheduling sequence selects the type of cells corresponding to the greatest QoS demand metric.

11. A method as in claim 9, wherein the consecutive durations of time assigned to a given type of cells according to the scheduling sequence do not exceed a predetermined maximum.

12. A method as in claim 11, wherein the predetermined maximum relates to a time period greater than which interruption of service may occur.

13. A method as in claim 8, wherein the duration of time is fixed.

14. A method as in claim 1, wherein the method is carried out by a network control unit in the cellular communication system.

15. A method as in claim 1, wherein the method is carried out by a plurality of interconnected base stations within the plurality of cells.

16. A cellular communication system, comprising a plurality of cells each having a geographical area with which it provides communication services to mobile stations, wherein the cells are classified into a plurality of types, such that each cell of a given type is adjacent only to cells of types other than the given type; and wherein a predetermined bandwidth is assigned exclusively for use in communication to each type of cells, one type at a time, according to a predetermined scheduling sequence and for a duration of time.

17. A communication system as in claim 16, wherein the scheduling sequence comprises a round-robin schedule.

18. A communication system as in claim 17, wherein the duration of time is fixed.

19. A communication system as in claim 17, wherein the duration of time varies according to a quality of service (QoS) demand metric computed in each type of cells.

20. A communication system as in claim 19, wherein the duration of time assigned to a type of cells is proportional to the QoS demand metric computed for that type of cells, relative to the QoS demand metrics computed across all the classified types of cells.

21. A communication system as in claim 20, wherein the durations of time in total assigned to all the classified type of cells in one rotation of the round-robin schedule do not exceed a predetermined maximum.

22. A communication system as in claim 21, wherein the predetermined maximum relates to a time period greater than which interruption of service may occur.

23. A communication system as in claim 16, wherein the scheduling sequence assigns selects a type of cells to assign the bandwidth prior to the beginning of each duration of time.

24. A communication system as in claim 23, wherein the scheduling sequence selects the type of cells according to a quality of service (QoS) demand metric computed for each type of cells at the beginning of each duration of time.

25. A communication system as in claim 24, wherein the scheduling sequence selects the type of cells corresponding to the greatest QoS demand metric.

26. A communication system as in claim 24, wherein the consecutive durations of time assigned to a given type of cells according to the scheduling sequence do not exceed a predetermined maximum.

27. A communication system as in claim 26, wherein the predetermined maximum relates to a time period greater than which interruption of service may occur.

28. A communication system as in claim 23, wherein the duration of time is fixed.

29. A communication system as in claim 15, further comprising a network control unit in the cellular communication system for carrying out the scheduling sequence and determining the duration of time.

30. A communication system as in claim 15, wherein the cells further comprise a plurality of interconnected base stations, the base stations carrying out the scheduling sequence and determining the duration of time.
